(19) United States
(12) Patent Application Publication
(10) Pub. No.: US 2007/0064896 A1
(43) Pub. Date: Mar. 22, 2007

(54) System and method for sharing SIP sessions

(76) Inventors: Su-Yuan Chang, Chutung (TW); Yin-JU Chen, Chutung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/208,710

(22) Filed: Aug. 23, 2005

(51) Int. Cl. H04M 1/00

(52) U.S. Cl. 379/156

(57) ABSTRACT

This present invention provides a communication system, which comprises a SIP (Session Initiation Protocol) call server and a virtual SIP user agent. SIP services are provided by said SIP call server for a plurality of internal SIP user agents. The virtual SIP user agent is connecting to said SIP call server and an external SIP proxy server. At least one external SIP account is registered by said virtual SIP user agent to said external SIP proxy server. SIP communication between any of said plurality of internal SIP user agents and an external SIP user agent is exchanged by said virtual SIP user agent.

### BACKGROUND OF THE INVENTION

1. Field of the Invention

The present invention generally relates to SIP (Session Initiation Protocol), and more particularly to system and method for sharing SIP sessions.

2. Description of the Prior Art

SIP (Session Initiation Protocol) is a growing communication solution. It is more flexible and cheaper than traditional circuit switched communication network. Traditionally, SIP users have to register user accounts in order to facilitate SIP functionalities. The registered user accounts are managed, charged, and billed by service providers.

In a scenario, a certain number of SIP subscription accounts are applied by a company or an organization. However, the number of employees or member of this company or organization is often more than the subscription account number. Therefore there is no one-to-one mapping existed between accounts and the phones of employees. In the consequence, external caller cannot call a specified employee directly, and vice versa. The problem could be addressed in two reasons. First, since internal SIP phones do not register to external SIP server, outer SIP phones could not find these un-registered SIP phones. Second, these un-registered internal SIP phones could not dial out via the external SIP server.

Accordingly, there exists a need for a system and method for sharing the SIP sessions registered at external service providers.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

An object of this present invention is to provide a communication system, which comprises a SIP (Session Initiation Protocol) call server and a virtual SIP user agent. SIP services are provided by said SIP call server for a plurality of internal SIP user agents. The virtual SIP user agent is connecting to said SIP call server and an external SIP proxy server. At least one external SIP account is registered by said virtual SIP user agent to said external SIP proxy server. SIP communication between any of said plurality of internal SIP user agents and an external SIP user agent is exchanged by said virtual SIP user agent.

Another object of this invention is to provide a communication method, which comprises providing a SIP (Session Initiation Protocol) call server. SIP services are provided by said SIP call server for a plurality of internal SIP user agents. The method further comprises providing a virtual SIP user agent connecting to said SIP call server and an external SIP proxy server. At least one external SIP account is registered by said virtual SIP user agent to said external SIP proxy server. Moreover, the method also comprises exchanging, by said virtual SIP user agent, SIP communication between any of said plurality of internal SIP user agents and an external SIP user agent.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates a communication system of an embodiment in accordance with the present invention;

FIG. 2A is a diagram depicts a sequence diagram of a call flow initiated by the internal user agent via the virtual user agent;

FIG. 2B is a diagram illustrates a sequence diagram of another call flow initiated by the internal user agent via the virtual user agent; and

FIGS. 3A and 3B are diagrams show a sequence diagram of a call flow initiated by the external user agent via the virtual user agent.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

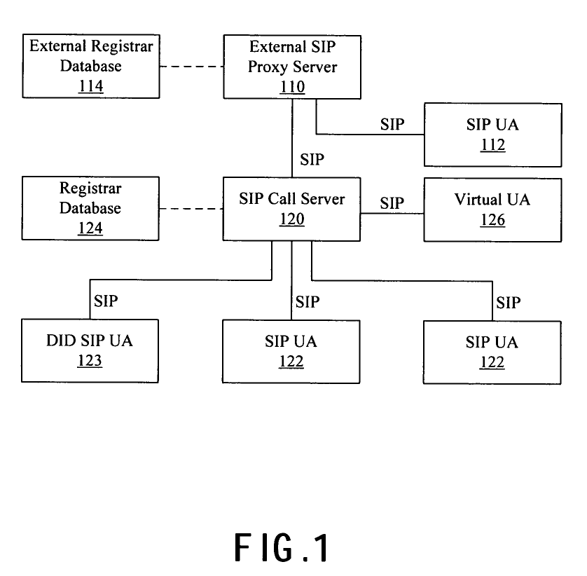

Please refer to FIG. 1, which is a block diagram shows a system 100 of an embodiment in accordance with the present invention. In this system 100, an external SIP proxy server 110 provides SIP services for a plurality of registered external SIP user agents 112. The account information of these external user agents 112 is managed by at least one external registrar database 114, connecting to the external SIP proxy server 110. Both the external SIP proxy server 110 and registrar database 114 are operated and maintained by a service operator. In addition, the plurality of user agents 114 may be billed by the operator of the external SIP proxy server 110.

As shown in the FIG. 1, a SIP call server 120, provides SIP services for a plurality of internal SIP user agents 122 in an organization, can reach to the external SIP proxy server 110. Similarly, the account information of those internal user agents 122 is managed by an internal registrar database 124, connecting to the SIP call server 120. Any internal user agents 122 can perform SIP-defined operations among the plurality of internal user agents 122. In this regards, at least one external user account, registering to the external SIP proxy server 110, is owned by the call server 120. The call server 120 may comprises a virtual SIP user agent 126 for operating the external user account. In one example of this embodiment, a special DID (Dial-In Directly) internal user agent 123 have an internal account and an external account for registering both the internal SIP call server 120 and the external SIP proxy server 110, respectively. Therefore DID user agent 123 could call outer SIP user agents via the external SIP proxy server 110 or call inner SIP user agents via the internal SIP call server 120 depending on the location and/or number of the callee.

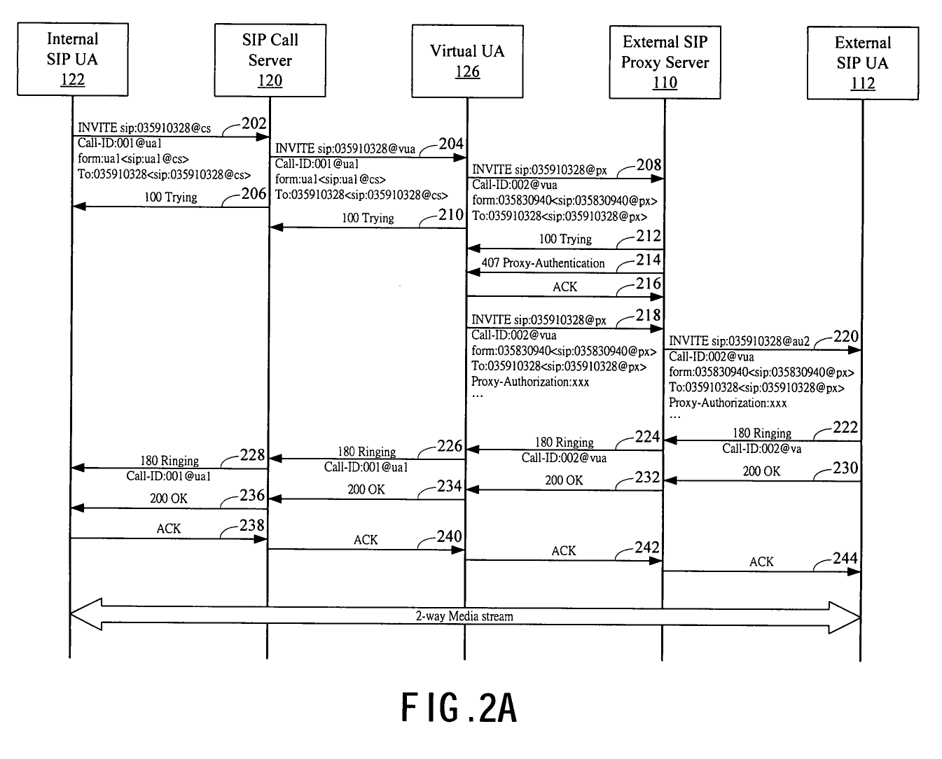

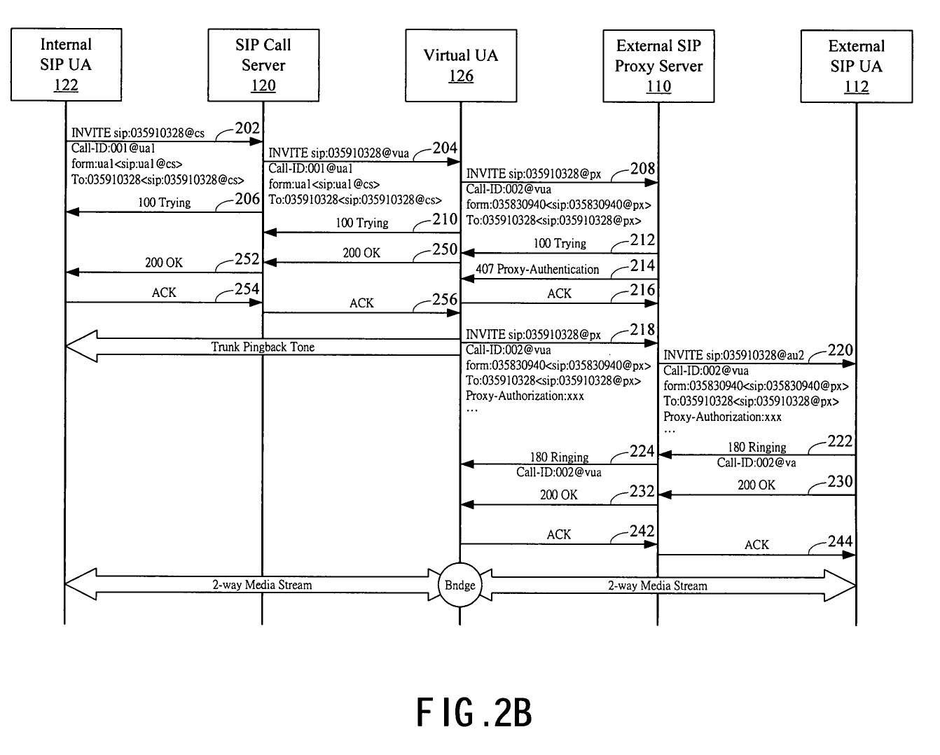

Please refer to FIG. 2A, which illustrates a sequence diagram of a call flow initiated by the internal user agent 122 via the virtual user agent 126. After registrations, the internal user agent 122 makes a call to one of the external user agents 112. At step 202, the internal user agent 122 sends an INVITE SIP message to the SIP call server 120. After receiving the INVITE message, the internal SIP call server 120 determines that the callee is not internal. Therefore, another INVITE message is sent to the virtual user agent 126 at step 204. Meanwhile, a trying message is returned to the caller at step 206. The virtual user agent 126, already registered to the external SIP proxy server 110, issues another INVITE message to the external SIP proxy server 110 using the external account at step 208. Similarly, another trying message is returned to the internal SIP call server 120 by the virtual user agent 126 at step 210. Receiving the INVITE message, at step 212, the external SIP proxy server 110 returns a trying message to the virtual user agent 126 at first. Account authentication is facilitated at step 214 by the external SIP proxy server 110. After sending the ACK (Acknowledgement) message at step 216 by the virtual user agent 126, another INVITE message with proxy authentication data is re-sent to the external SIP proxy server 110 at step 218.

As shown in the FIG. 2A, the INVITE message is relayed to the destination user agent 112 at step 220. A ringing message is returned to the callee by the caller along the way at steps 222, 224, 226, and 228. After someone un-hooks the SIP user agent 112, an OK message is passed to the caller at steps 230, 232, 234, and 236. Once receiving the ACK message from the caller along the steps 238, 240, 242, and 244, an end-to-end two-way media stream path is built up between the caller and the callee.

Please refer to FIG. 2B, which illustrates a sequence diagram of another call flow initiated by the internal user agent 122 via the virtual user agent 126. The steps 202 to 224, shown in the FIG. 2B, are as the same as the steps shown in the FIG. 1A. However, after receiving the trying message from the external SIP proxy server 110 at step 212, the virtual user agent 126 sends an OK message to the caller at steps 250 and 252. In response of this OK message, an ACK message returned by the caller is sent to the virtual user agent 126. It means the two-way media stream between the internal user agent 122 and the virtual user agent 126 has set up ready.

As shown in the FIG. 2B, after someone un-hooks the SIP user agent 112, an OK message is passed to the virtual user agent 126 at steps 230 and 232. Once the callee receives an ACK message issued by the virtual user agent 126 at steps 260 and 262, it means the two-way media stream between the external user agent 112 and the virtual user agent 126 has set up ready. Therefore, the caller and callee could communicate to each other via the bridged relay of the virtual user agent 126.

In this present invention, the call flow of system 100 could be configured as FIG. 2A or FIG. 2B. It depends on considerations of system load, overheads, and/or interception issues. As shown in the FIG. 2B, the virtual user agent 126 may copy or re-direct the media stream to any 3-party for recording and/or legal interception.

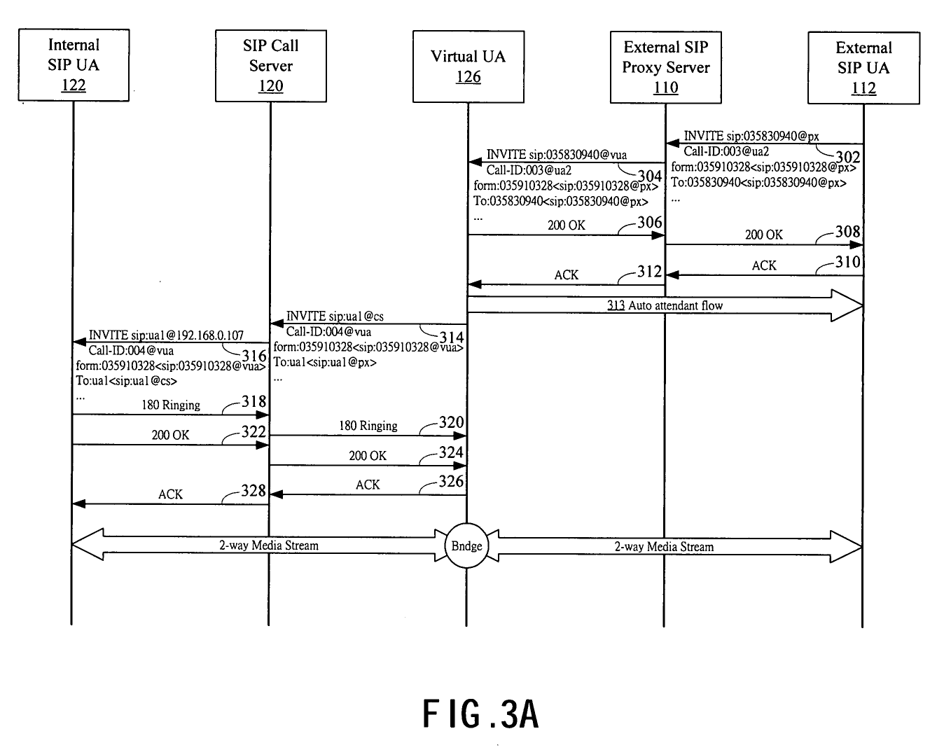

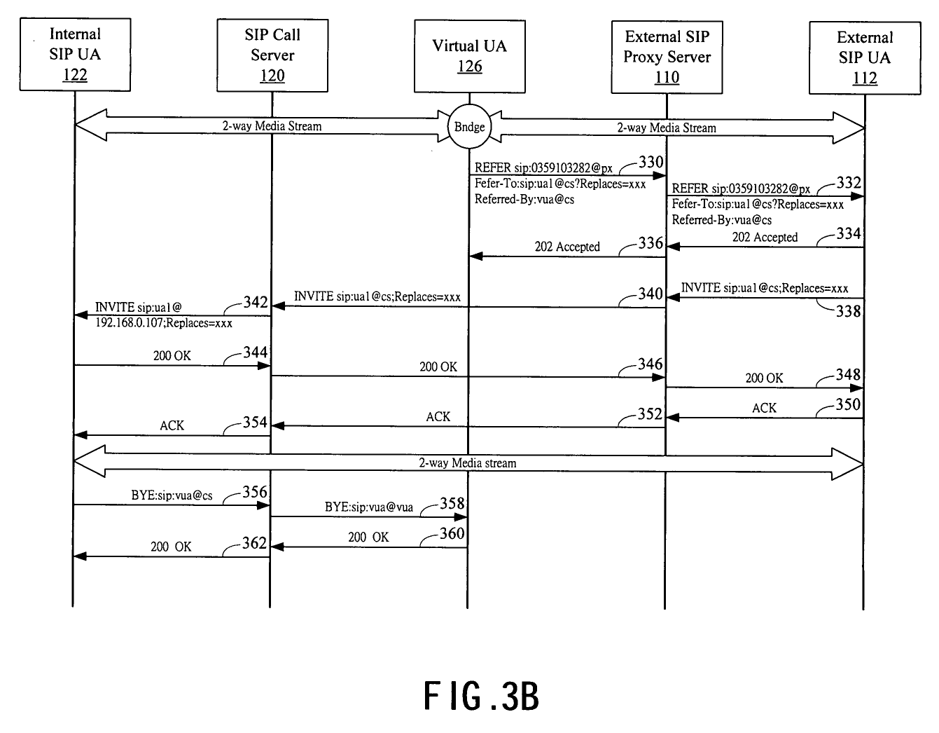

Please refer to FIGS. 3A and 3B, which shows a sequence diagram of a call flow initiated by the external user agent 126 via the virtual user agent 126. After registering all external accounts, the caller, the external SIP user agent 112 makes a call to one of the internal user agent 122 by issuing an INVITE message to the external SIP proxy server 110 at step 302. Next, the INVITE message is relayed to the virtual user agent 126 at step 304. In this regards, the virtual user agent 126 may send back an OK message in response of the relayed INVITE message at step 306 and 308. Therefore, the caller returns an ACK message to the broker, the virtual user agent 126, at the following steps 310 and 312. Meanwhile, an automatic attendant flow 313 could be played or programmed.

In an example, the automatic attendant flow 313 may comprises a series of voice prompts for the caller, the external user agent 126. Following the series of voice prompts, the caller may sends extension number referred to the intended internal user agent 122. After receiving the extension number, the virtual user agent 126 could call the callee internally. In another example, the external user agent 126 could send some information referred to one department, one functional group, or even another automatic attendant flow. Then the virtual user agent 126 could call the dynamically determined callee after receiving the information provided by the automatic attendant flow 313.

As shown in the FIGS. 3A and 3B, the virtual user agent 126 sends an INVITE message to the SIP call server 120 at step 314. Next, another INVITE message is sent to the callee by the SIP call server 120 at step 316. A ringing message is forwarded back to the virtual user agent 126 at steps 318 and 320 until someone answers the call. Therefore both the virtual user agent 126 and callee exchange OK and corresponding ACK message at step 322, 324, 326, and 328. The caller and the callee could communicate to each other via the bridged relay of the virtual user agent 126.

If the intermediated virtual user agent 126 does not want to bridge the media stream, it could ask the caller talking to the callee directly. A REFER message, augmented with the address of callee, is sent to the external SIP proxy 110 by the virtual user agent 126 at step 330. Next, the REFER message is forwarded to the caller at step 332. If the caller agrees, an acceptance message would be returned to the virtual user agent 126 at steps 334 and 336. In this regards, another INVITE message, augmented with the address of callee as replacement, is sent to the external SIP proxy server 110 at step 338. This INVITE message would be forwarded to the internal SIP call server 120 at the following step 340. At step 342, a new INVITE message, issued by the internal SIP call server 120, would be received by the callee, the internal user agent 122. Therefore, a corresponding OK message and a corresponding ACK message are exchanged between the caller and callee at the following steps 344, 346, 348, 350, 352, and 354. It means an end-to-end two-way media stream path is built up between the caller and the callee. After that, at steps 356, 358, 360, and 362, a BYE message and a corresponding OK message are exchanged between the callee and the virtual user agent 126 in order to abandon the media stream between them.

In the mentioned call flows, the external user accounts could be shared by the internal user agents via the bridge of virtual user agent. It may save some basic charges of external user accounts and/or raise utilization rate of external user accounts.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A communication system, comprising:
a SIP (Session Initiation Protocol) call server, wherein SIP services are provided by said SIP call server for a plurality of internal SIP user agents; and
a virtual SIP user agent, connecting to said SIP call server and an external SIP proxy server, wherein at least one external SIP account is registered by said virtual SIP user agent to said external SIP proxy server, SIP communication between any of said plurality of internal SIP user agents and an external SIP user agent is exchanged by said virtual SIP user agent.

2. A communication system of claim 1, further comprising a DID (dial-in directly) user agent registering to said SIP call server and said external SIP proxy server, wherein any of said plurality of internal SIP user agents is called by said DID user agent via said SIP call server, and said external SIP user agent is called by said DID user agent via said external SIP proxy server.

3. A communication system of claim 1, wherein said external SIP user agent is called by any of said plurality of internal SIP user agents via said virtual SIP user agent.

4. A communication system of claim 3, wherein said virtual SIP user agent bridges media streams between said external SIP user agent and any of said plurality of internal SIP user agents.

5. A communication system of claim 3, wherein said external SIP user agent exchanges media streams with any of said plurality of internal SIP user agents directly.

6. A communication method, comprising:
providing a SIP (Session Initiation Protocol) call server, wherein SIP services are provided by said SIP call server for a plurality of internal SIP user agents;
providing a virtual SIP user agent, connecting to said SIP call server and an external SIP proxy server, wherein at least one external SIP account is registered by said virtual SIP user agent to said external SIP proxy server; and
exchanging, by said virtual SIP user agent, SIP communication between any of said plurality of internal SIP user agents and an external SIP user agent.

7. A communication method of claim 6, further comprising:
providing a DID (dial-in directly) user agent registering to said SIP call server and said external SIP proxy server, wherein any of said plurality of internal SIP user agents is called by said DID user agent via said SIP call server, and said external SIP user agent is called by said DID user agent via said external SIP proxy server.

8. A communication method of claim 6, further comprising:
calling said external SIP user agent, by any of said plurality of internal SIP user agents, via said virtual SIP user agent.

9. A communication method of claim 8, further comprising:
bridging, by said virtual SIP user agent, media streams between said external SIP user agent and any of said plurality of internal SIP user agents.

10. A communication method of claim 8, further comprising:
exchanging, by said external SIP user agent, media streams with any of said plurality of internal SIP user agents directly.
